(19) United States
(12) Patent Application Publication
(10) Pub. No.: US 2008/0146139 A1
(43) Pub. Date: Jun. 19, 2008

(54) Low-profile air conditioning register

(75) Inventors: Nobuhiro Terai, Aichi-ken (JP); Minoru Shibata, Aichi-ken (JP); Takahiko Sato, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 11/987,038

(22) Filed: Nov. 27, 2007

(30) Foreign Application Priority Data
Dec. 15, 2006 (JP) 2006-338537

(51) Int. Cl. B60H 1/34

(52) U.S. Cl. 454/155

(57) ABSTRACT

A low-profile air conditioning register is provided with a retainer, a bezel and a plurality of downstream fins. The bezel is arranged in such a manner as to position a lower long side of an opening of a passage portion in a downstream than an upper long side. The angle formed between a flange portion and the ventilation direction of the retainer is equal to or more than 60°. Further, the length of a corresponding line to a short side of the opening in a surface which is orthogonal to the ventilation direction is equal to or less than 35 mm. Further a lower inner wall in the passage portion is inclined with respect to the ventilation direction in such a manner as to become lower toward a downstream side. The lower inner wall surface has a length equal to or less than 10 mm along a thickness direction of the flange portion.

### BACKGROUND OF THE INVENTION

The present invention relates to a low-profile air conditioning register that has a rectangular opening serving as an air outlet for air sent from an air conditioner, and regulates the direction of air blown out of the opening.

In a vehicle such as an automobile, in order to operate a device such as a navigation system, and to display a state of the device, there is a case that a display device is installed in a center cluster of an instrument panel. In this case, as shown by a solid line in FIG. 12, a display portion 91 (a screen portion) of the display device is arranged in an upper portion of a center cluster 92. This is for the purpose of reducing the distance at which a view point of a driver moves at a time when the driver transfers the view point from a window glass to the display portion. Further, the upper portion of the center cluster 92 is provided with air conditioning registers 93 constituting an air outlet of an air conditioner, in addition to the display portion 91. Conventionally, the air conditioning registers 93 are arranged on both sides of the display portion 91.

In recent years, in order to improve the visibility, there has been a demand for enlargement in size of the display portion 91. Accordingly, as shown by two-dot chain lines in FIG. 12, the dimension in the vehicle width direction of the display portion 91 has been enlarged, and the positions of the air conditioning registers 93 have been accordingly changed in the vehicle width direction.

However, in this case, since the right air conditioning register 93 comes close to a steering wheel 94, the following problems are generated. As one of them, there is a problem that since the air blown out of the right air conditioning register 93 is directly applied to an arm of the driver holding the steering wheel 94, the driver feels disturbed. Further, since the air blown out of the right air conditioning register 93 is obstructed by the arm of the driver, there is a case that the air cannot be circulated within the passenger compartment.

As a countermeasure against the problem, the air conditioning register 93 may be arranged immediately above the display portion 91 in place of both sides of the display portion 91. However, if the conventional air conditioning register 93 is arranged immediately above the display portion 91 in its original shape, the height of an instrument panel 95 is increased. As a result, an open feeling within the passenger compartment cannot be obtained, and the passenger may feel cramped or confined. Accordingly, in order to limit the height of the instrument panel 95, there have been attempts to arrange a low-profile air conditioning register immediately above the display portion 91.

For example, in a low-profile air conditioning register 96 shown in FIG. 13, a retainer having a low height is used as a retainer 97 through which air passes. A bezel 98 is installed to the retainer 97 from a downstream side thereof. The bezel 98 has a passage portion 99 passing the air therethrough, and a flange portion 100 provided around a downstream end of the passage portion 99. A wide and rectangular opening 101 is formed in an upstream end of the passage portion 99. An end surface in a downstream side of the retainer 97 and the flange portion 100 of the bezel 98 are both inclined in the advancing direction of the vehicle in such a manner as to recede from a driver's seat and a front passenger seat toward an upper side. Further, an upper inner wall surface 104 in the passage portion 99 is inclined so as to be higher toward a downstream side, and a lower inner wall surface 105 is inclined so as to be lower toward the downstream side. A plurality of upstream fins 102 are arranged within the retainer 97 in such a manner that an angle thereof can be adjusted in a lateral direction, and a plurality of downstream fins 103 are arranged in such a manner that an angle thereof can be adjusted in a vertical direction.

In the low-profile air conditioning register 96, it is possible to change the direction of a windblown out of the bezel 98 to the right and left by adjusting the angle of the upstream fin 102. Further, it is also possible to change the direction of the wind blown out of the bezel 98 up and down by adjusting the angle of the downstream fin 103.

Low-profile air conditioning registers basically having the same structure as mentioned above are described in Japanese Laid-Open Patent Publication No. 2005-350029, Japanese Laid-Open Utility Model Publication No. 5-16525 and Japanese Laid-Open Patent Publication No. 2003-34136.

FIG. 14 shows an air flow rate distribution Ds1 within the retainer 97, and an air flow rate distribution Ds2 in the opening 101 of the bezel 98. For convenience of explanation, the upstream fin 102 and the downstream fin 103 within the retainer 97 shown in FIG. 13 are omitted. In accordance with the flow rate distribution Ds1 shown in FIG. 14, the flow rate becomes maximum in a center of the flow path within the retainer 97, and the flow rate is reduced as the distance from the center increases. Originally, as shown by a two-dot chain line in FIG. 14, it is desirable that the air flow at the flow rate distribution Ds2 even at the opening 101.

However, a Coanda flow is generated in the opening 101 of the bezel 98 due to the lower inner wall surface 105 of the passage portion 99. A main stream (a potential core layer) 106 of the flow rate distribution Ds2 is pulled toward the inner wall surface 105 due to the Coanda flow. As a result, the original flow rate distribution Ds2 is changed to a flow rate distribution Ds3 shown by a solid line in FIG. 14. In the flow rate distribution Ds3, the flow rate at a position at which the flow rate of the air is maximum in the flow rate distribution Ds1 is largely lowered (attenuated). Accordingly, the intensity (a wind speed) of the wind applied to the passenger comes short. It is apparent from experiments that the phenomenon mentioned above tends to be generated in the case that the length H of a line corresponding to a short side A at an upstream end of the passage portion 99 is equal to or less than 35 mm, and the flange portion 100 intersects at an angle θ smaller than 60° with respect to a ventilating direction X, in a plane that is orthogonal to the ventilating direction X in the retainer 97. The problem mentioned above is also generated in the same manner in the low-profile air conditioning registers disclosed in Japanese Laid-Open Patent Publication No. 2005-350029, Japanese Laid-Open Utility Model Publication No. 5-16525 and Japanese Laid-Open Patent Publication No. 2003-34136 having the same basic structure as FIG. 13.

### SUMMARY OF THE INVENTION

An objective of the present invention is to provide a low-profile air conditioning register that prevents the intensity of wind applied to a user from being lowered due to attenuation of the flow rate distribution in an opening of a bezel caused by a Coanda flow.

To achieve the foregoing objective and in accordance with one aspect of the present invention, an air conditioning register for regulating a direction of air blown out of an air conditioner into a passenger compartment is provided. The register includes a tubular retainer, and a bezel provided in a downstream end of the retainer. The bezel has a passage portion distributing the air from the interior of the retainer, and a flange portion provided in the periphery of a downstream end of the passage portion. An opening is positioned in an upstream end of the passage portion. The opening is formed in a rectangular shape and has first and second long sides and first and second short sides. Fins are arranged along the first short side of the opening and in a state of being spaced from each other. Each of the fins is arranged so as to be adjustable in angle within the retainer. The flange portion and a ventilation direction within the retainer intersect at an angle equal to or more than 60° in such a manner that the first long side in the opening is positioned downstream of the second long side. The length of a side corresponding line to the first short side of the opening is equal to or less than 35 mm in a plane which is orthogonal to the ventilation direction. An inner wall surface including the first long side in the passage portion is inclined with respect to the ventilation direction in such a manner as to enlarge the interval between the inner wall surface and an inner wall surface including the second long side as the distance from a downward side decreases. An inner wall surface including the first long side has a length equal to or less than 10 mm along a thickness direction of the flange portion.

### BRIEF DESCRIPTION OF THE DRAWINGS

FIG. 1 is a partial front view showing a center cluster in which a low-profile air conditioning register in accordance with one embodiment of the present invention is installed;

FIG. 2 is an enlarged front view showing the low-profile air conditioning register;

FIG. 3 is an enlarged cross-sectional view taken along line 3-3 in FIG. 2;

FIG. 4 is a partial side view showing a state in which a bezel is detached from the low-profile air conditioning register;

FIG. 5 is a partial side view showing a state before an end fin and an intermediate fin are attached to a retainer;

FIG. 6 is a partial perspective view showing an upper end fin and a link mechanism;

FIG. 7 is a partial cross-sectional view showing a portion near the bezel in the low-profile air conditioning register;

FIG. 8 is a partial cross-sectional view showing a state of a downstream fin at a time when an operating knob is operated upward from the state in FIG. 3;

FIG. 9 is a partial cross-sectional view showing a state of the downstream fin at a time when the operating knob is operated downward from the state in FIG. 3;

FIG. 10 is an explanatory view showing flow rate distributions within the retainer and in the bezel;

FIG. 11 is a graph showing a relationship between the distance from the low-profile air conditioning register and a maximum wind speed;

FIG. 12 is a partial front view showing a center cluster in which a conventional low-profile air conditioning register is installed;

FIG. 13 is a partial cross-sectional view showing an internal structure of the conventional low-profile air conditioning register; and

FIG. 14 is an explanatory view showing flow rate distributions within the retainer and in the bezel.

### DETAILED DESCRIPTION OF THE PREFERRED EMBODIMENTS

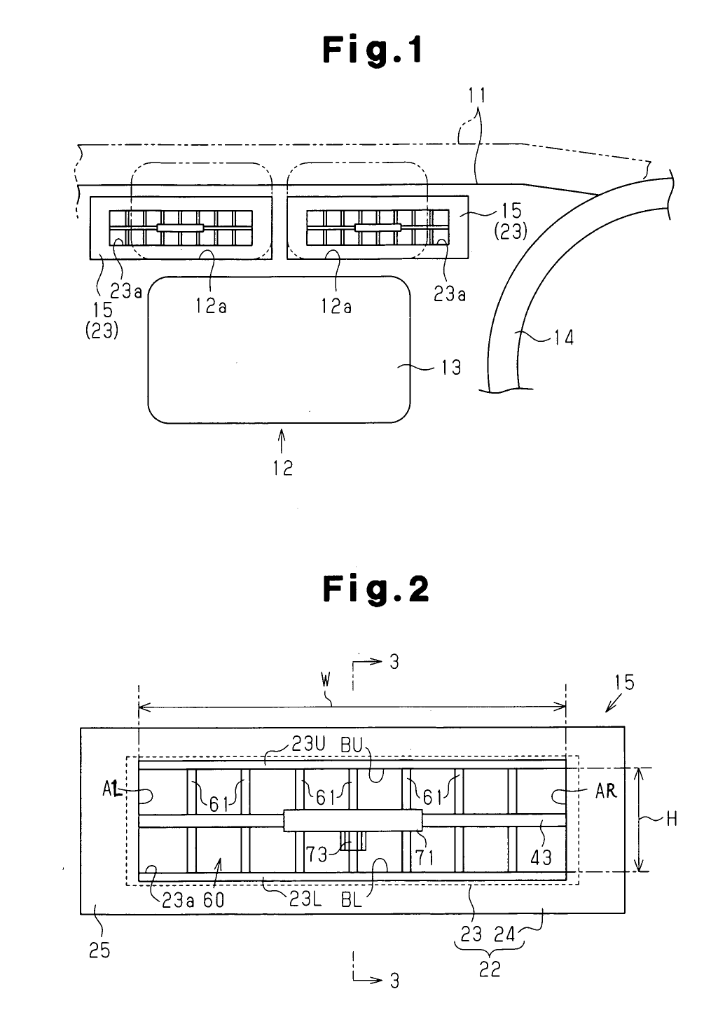

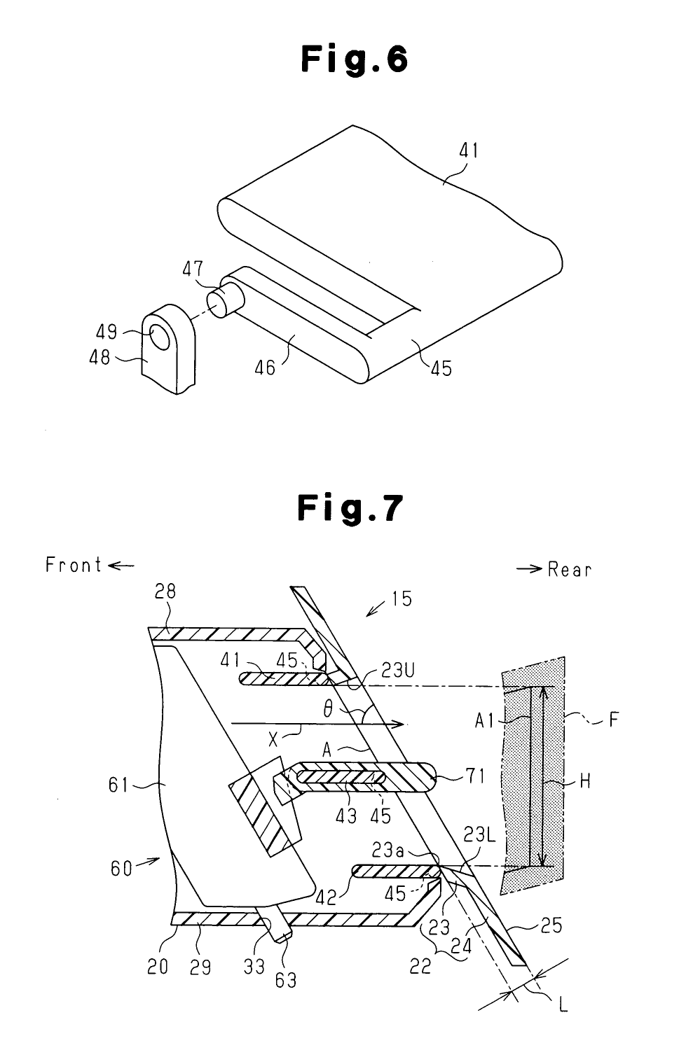

A description will be given below of a low-profile air conditioning register according to one embodiment applied to a vehicle with reference to FIGS. 1 to 11. At a time of describing the low-profile air conditioning register, a forward moving direction of a vehicle is defined as a front side, a backward moving direction is defined as a rear side, and a height direction is defined as a vertical direction. Further, with respect to a vehicle width direction, right and left sides are defined on the basis of a direction at a time of viewing the vehicle from the rear side.

As shown in FIG. 1, an instrument panel 11 is provided in a front side of a driver's seat and a front passenger seat, within a passenger compartment. In the instrument panel 11, a center cluster 12 is provided in the center in the vehicle width direction. A display portion 13 of a display device in a navigation system is attached to an upper portion of the center cluster 12. The display portion 13 is positioned in a left front side of a steering wheel 14 of a steering apparatus.

A pair of low-profile air conditioning registers 15 are installed immediately above the display portion 13 in an upper portion of the center cluster 12, in a state of being lined up in the vehicle width direction. Each low-profile air conditioning register 15 regulates a direction of an air blown off into the passenger compartment from an air conditioner, and shuts off the blowoff of the air.

Both low-profile air conditioning registers 15 are arranged at the positions mentioned above because the following problems are generated in the case that the low-profile air conditioning registers are arranged on both sides of the display portion 13. One of the problems is that the driver would feel disturbed because air blown out of the right low-profile air conditioning register 15 would be directly applied to an arm of the driver holding the steering wheel 14. Another problem is that the air blown out of the right low-profile air conditioning register 15 would be hardly circulated within the passenger compartment because the air flow would be prevented by the arm of the driver.

In the case that air conditioning registers shown by a two-dot chain line in FIG. 1 are installed immediately above the display portion 13, the height of the instrument panel 11 will be increased. As a result, an open feeling within the passenger compartment cannot be obtained, and the user (an occupant of the vehicle) may feel a feeling cramped or confined. Accordingly, in order to dissolve such cramped and confined feeling, low-profile air conditioning registers 15 as shown by solid lines in FIG. 1 are employed for lowering the height of the instrument panel 11.

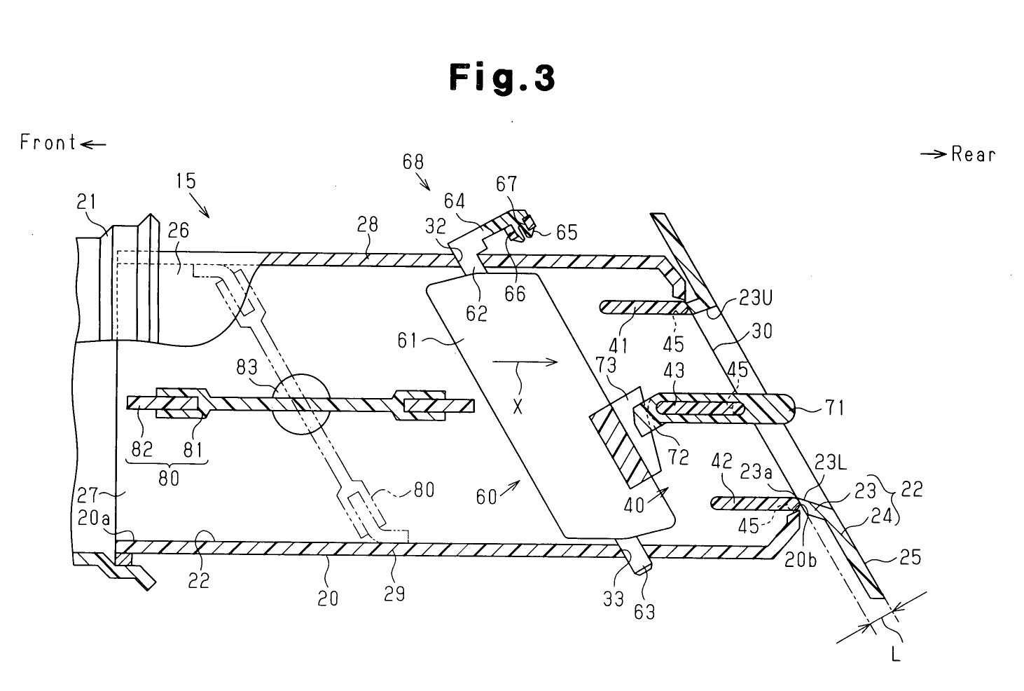

The pair of low-profile air conditioning registers 15 have approximately the same structure. As shown in FIGS. 2 and 3, each of the low-profile air conditioning registers 15 is provided with a retainer 20, a bezel 22, a downstream fin group 40, an upstream fin group 60, and a shut damper 80.

### <Retainer 20>

The retainer 20 is structured such as to connect a ventilation duct 21 of an air conditioner, and an opening 12a (refer to FIG. 1) provided in the center cluster 12. An internal space of the retainer 20 forms a flow path of air. The retainer 20 is constituted by a tubular body provided with openings in both ends. An upstream opening 20a in the retainer 20 corresponds to an introduction port of the air fed out from the ventilation duct 21, and is formed in a wide rectangular shape. Further, a downstream opening 20b in the retainer 20 is also formed in a wide rectangular shape. The height of the downstream opening 20b is smaller than that of the upstream opening 20a.

The retainer 20 is provided with four wall portions surrounding the flow path. In order to distinguish these four wall portions, a wall portion corresponding to a first short side (left side) of the opening 20b is referred to as a left wall portion 26, a wall portion corresponding to a second short side (right side) of the opening 20b is referred to as a right wall portion 27. Also, a first wall portion corresponding to a first long side (lower side) of the opening 20b is referred to as a lower wall portion 29, and a second wall portion corresponding to a second long side (upper side) of the opening 20b is referred to as an upper wall portion 28. In the present embodiment, since the opening 20b is formed in the wide rectangular shape, the mutually opposing walls along the vehicle width direction correspond to the left and right wall portions 26 and 27, and the mutually opposing wall portions in the vertical direction correspond to the upper and lower wall portions 28 and 29. Within the retainer 20, the air flows along a ventilation direction shown by an arrow X. The ventilation direction X is in parallel to the upper and lower wall portions 28 and 29, and is in parallel to a horizontal plane.

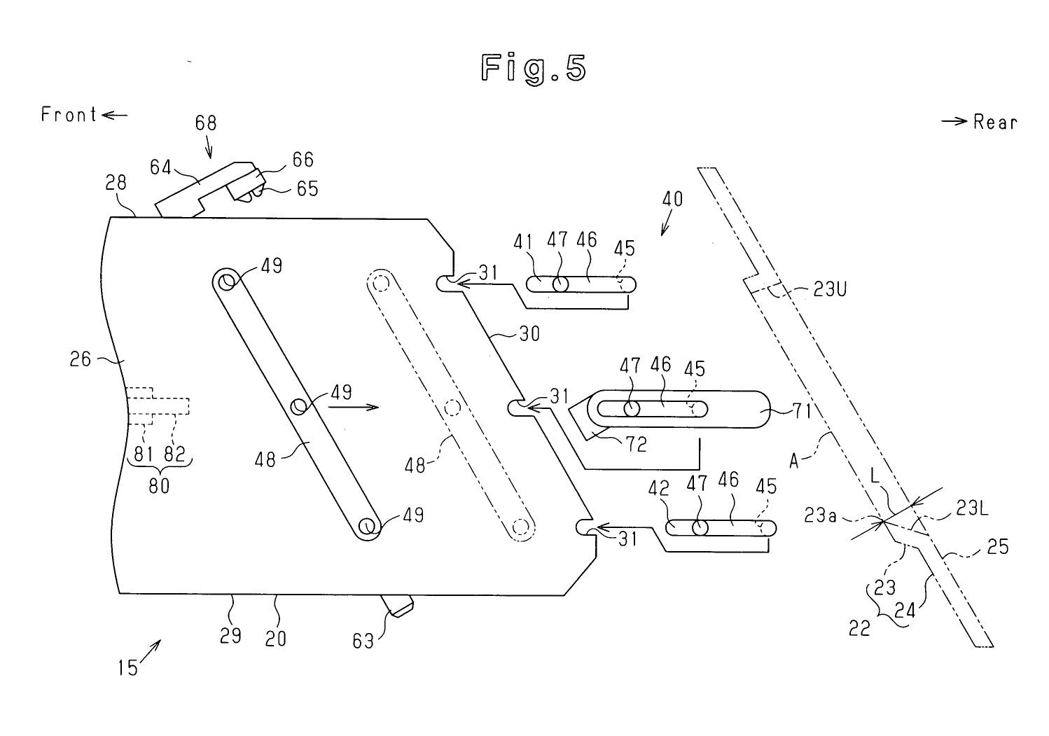

As shown in FIGS. 3 and 5, in a downstream edge 30 of each of the left and right wall portions 26 and 27, a position corresponding to the opening 20b is inclined with respect to the ventilation direction X in such a manner as to recede from the driver's seat and the front passenger seat toward the front side as the distance from the upper side decreases. In each of the left and right wall portions 26 and 27, three bearing recesses 31 are provided in each of the inclined downstream edges 30 so as to be spaced at a uniform interval. The bearing recess 31 in a highest stage is positioned immediately below the upper long side of the opening 20b, and the bearing recess 31 in a lowest stage is positioned immediately above the lower long side of the opening 20b.

Further, a plurality of bearing portions 32 are provided in the upper wall portion 28 so as to be spaced at a uniform interval along the upper long side of the opening 20b. In correspondence thereto, a plurality of bearing portions 33 are provided in the lower wall portion 29 so as to be spaced at a uniform interval along the lower long side of the opening 20b.

### <Bezel 22>

As shown in FIGS. 2 and 3, the bezel 22 is arranged in a downstream end of the retainer 20. The bezel 22 is formed in a rectangular tubular shape. The bezel 22 is provided with a passage portion 23 serving as a flow path of air passing through the retainer 20, and a flange portion 24 arranged in the periphery of a downstream end of the passage portion 23. An opening 23a in an upstream end of the passage portion 23 is formed in a wide rectangular shape. The height of the opening 23a is smaller than that of the opening 20b of the retainer 20. In order to distinguish the respective sides of the opening 23a, the left side, which is a first short side, is referred to as a short side AL, the right side, which is a second short side, is referred to as a short side AR, the upper side, which is a second long side, is referred to as an upper long side BU, and a lower side, which is a first long side, is referred to as a lower long side BL. In the present embodiment, the width W of the opening 23a, that is, the interval between the short sides AL and AR is 120 mm. An upper inner wall surface 23U of the passage portion 23 is inclined with respect to the ventilation direction X in such a manner as to become higher toward the downstream side. Further, a lower inner wall surface 23L is inclined with respect to the ventilation direction X in such a manner as to become lower toward the downstream side. Accordingly, the interval between the lower inner wall surface 23L and the upper inner wall surface 23U becomes larger as the distance from the downstream side decreases.

In the flange portion 24, a lower long side BL of the opening 23a is positioned downstream of an upper long side BU. In other words, the flange portion 24 is inclined in the advancing direction of the vehicle in such a manner as to recede from the driver's seat and the front passenger seat as the distance from the upper side decreases. A downstream end surface of the flange portion 24 forms an ornamental surface 25 of the low-profile air conditioning register 15.

The bezel 22 is installed to the retainer 20 from the downstream side while causing the passage portion 23 to contact or be close to the downstream edge 30 of the retainer 20. In this state, the upper wall portion 28 is positioned in a higher position than the corresponding upper long side BU of the opening 23a, and the lower wall portion 29 is positioned in a lower position than the corresponding lower long side BL of the opening 23a.

### <Downstream Fin Group 40>

The downstream fin group 40 is provided near the opening 20b within the retainer 20. The downstream fin group 40 is constituted by three downstream fins extending along the upper long side BU of the opening 22b. The downstream fins are arranged along the short sides AL, AR of the opening 20b so as to be in parallel to each other and in a spaced state.

In order to distinguish these three downstream fins, two fins that are positioned closed to the upper and lower sides BU, BL of the opening 20b, respectively, are referred to as end fins 41 and 42, and the fin positioned between the end fins 41 and 42 is referred to as an intermediate fin 43. The end fin 41 is arranged between the upper long side BU and the upper wall portion 28, and the end fin 42 is arranged between the lower long side BL and the lower wall portion 29.

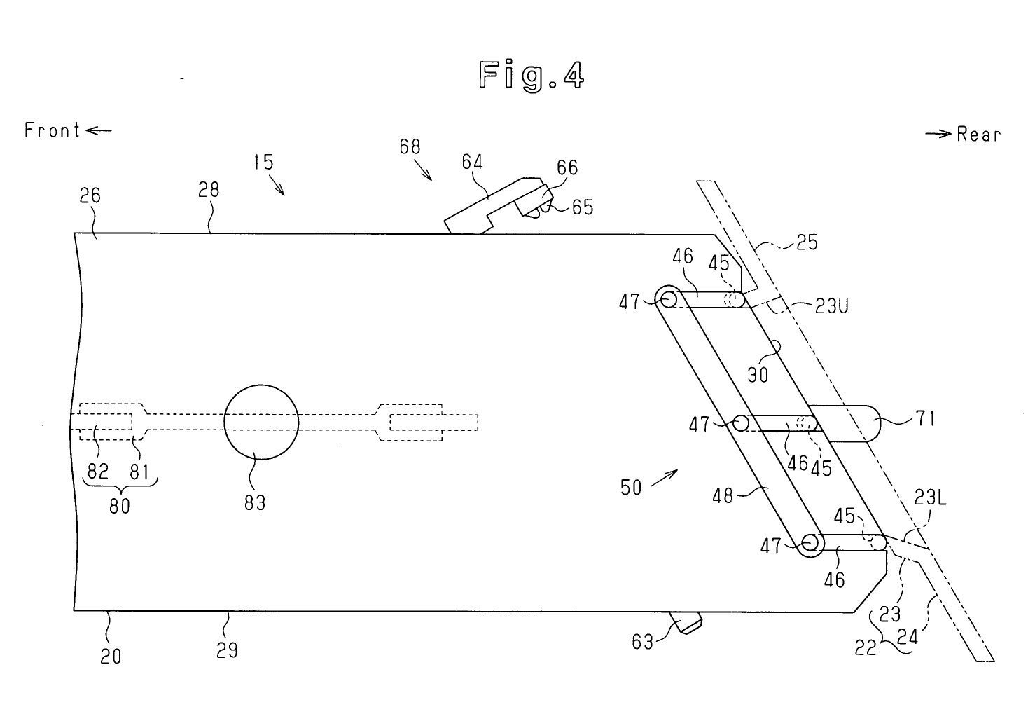

As shown in FIGS. 4 to 6, a support shaft 45 is provided in each of the end fins 41 and 42 and the intermediate fin 43. The support shaft 45 of each of the fins 41, 42 and 43 is rotatably engaged with each of the bearing recesses 31 of the retainer 20. Each of the support shafts 45 is held by the passage portion 23 of the bezel 22 in such a manner as to be prevented from falling off the bearing recess 31. Each of the end fins 41 and 42 and the intermediate fin 43 is tilted up and down along the short sides AL, AR around the support shaft 45. In this state, the bezel 22 is arranged near a downstream end of each of the end fins 41 and 42. Accordingly, each of the end fins 41 and 42 is concealed by the passage portion 23 of the bezel 22 (refer to FIG. 2).

The support shaft 45 of each of the end fins 41 and 42 and the intermediate fin 43 protrudes further outward than the corresponding left and right wall portions 26. An arm 46 is integrally formed in an end portion of each of the support shafts 45 protruding from the left wall portion 26. Each of the arms 46 extends straightly to an upstream side from the support shaft 45 as a starting point, and has a coupling projection 47 in an extended end portion.

The arms 46 are coupled to each other by an elongated coupling rod 48 extending in the vertical direction. The coupling rod 48 has a plurality of holes 49 at positions corresponding to the end fins 41 and 42 and the intermediate fin 43. The coupling projection 47 of each of the arms 46 is rotatably engaged with each of the holes 49 of the coupling rod 48. In the present embodiment, a link mechanism 50 mechanically coupling the end fins 41 and 42 and the intermediate fin 43 is constructed by the arm 46, the coupling projection 47, the coupling rod 48 and the like.

### <Upstream Fin Group 60>

As shown in FIGS. 2 and 3, the upstream fin group 60 is provided in a position upstream of the downstream fin group 40 within the retainer 20. The upstream fin group 60 is constituted by a plurality of upstream fins 61 extending along the short sides AL, AR of the opening 23a. The upstream fins 61 are arranged along the lower and upper long sides BL and BU of the opening 23a so as to be in parallel to each other and in a spaced state. Each of the upstream fins 61 is constituted by an approximately parallelogram thin plate, and is inclined in the advancing direction of the vehicle in such a manner as to recede from the driver's seat and the front passenger seat to the vehicle front side as the distance from the upper end decreases.

Support shafts 62 and 63 are respectively provided in an inclined state in both end surfaces of each of the upstream fins 61. The upper support shaft 62 is rotatably engaged with the bearing portion 32 of the upper wall portion 28, and the lower support shaft 63 is rotatably engaged with the bearing portion 33 of the lower wall portion 29. Accordingly, each of the upstream fins 61 is tilted along the upper and lower long sides BU and BL of the opening 23a around each of the support shafts 62 and 63.

The support shaft 62 provided in the upper end of each of the upstream fin 61 protrudes further upward than the upper wall portion 28. An arm 64 is formed in an end portion of each of the support shafts 62. Each of the arms 64 extends to a downstream side from the support shaft 62 serving as a starting point, and has a coupling projection 65 in an extended end portion.

Each of the arms 64 is coupled by an elongated coupling rod 66 extending along the vehicle width direction. The coupling rod 66 has a plurality of holes 67 at corresponding positions to the upstream fins 61. The coupling projection 65 of each of the arms 64 is rotatably engaged with each of the holes 67. In the present embodiment, a link mechanism 68 mechanically coupling each of the upstream fins 61 is constructed by the arm 64, the coupling projection 65, the coupling rod 66 and the like.

An operating knob 71 is fitted onto,the intermediate fin 43 (a specific downstream fin) so as to be slidable along the vehicle width direction. The inclination of the specific downstream fin and the specific upstream fin 61 is manually regulated by operating the operating knob 71. Further, a rack gear 72 is formed in an upstream portion of the operating knob 71. A pinion gear 73 with which a rack gear 72 is engaged is formed in the upstream fin 61 in the center.

### <Shut Damper 80>

The shut damper 80 is provided for opening and closing the flow path within the retainer 20, and is arranged in a position upstream of the upstream fin group 60. The shut damper 80 is provided with a damper plate 81 formed in a wide rectangular plate shape. The damper plate 81 has a seal member 82 installed all over an outer peripheral edge thereof.

The damper plate 81 is supported to the left and right wall portions 26 and 27 by a support shaft 83. The damper plate 81 is rotatable between a position (a position shown by a solid line in FIG. 3) at which the seal member 82 is arranged in parallel to the upper and lower wall portions 28 and 29, and an inclined position (a position shown by a two-dot chain line in FIG. 3) at which the seal member 82 comes into contact with the upper and lower wall portions 28 and 29. The low-profile air conditioning register 15 is provided with a damper operation portion (not shown) which is operated at a time of rotating the shut damper 80.

As shown in FIG. 7, in the opening 23a of the bezel 22, the lower inner wall surface 23L has a length equal to or less than 10 mm along the thickness of the flange portion 24. In the present embodiment, the length L is 5 mm.

In the case where the angle between the flange portion 24 and the ventilation direction X is indicated by θ, and the length of a line A1 corresponding to the short sides AL, AR of the opening 23a in an imaginary plane F which is orthogonal to the ventilation direction X is indicated by H, the length L of the inner wall surface 23L is set on the assumption that the low-profile air conditioning register 15 satisfies both of the following two conditions. The first condition is that the angle θ is equal to or more than 60°, and the second condition is that the length H is equal to or less than 35 mm. In the present embodiment, the angle θ is set to 60° in such a manner as to satisfy the condition mentioned above, and the length H is set to 30 mm. Further, the width W of the opening 23a is set to 120 mm.

The reason why the angle θ is set equal to or more than 60° is shown below. In the case that the angle θ is less than 60°, that is, in the case that the flange portion 24 is largely inclined, it is impossible to create a sufficient flow path between the adjacent downstream fins at a time of tilting the downstream fin. In this case, a flow path area of the passage portion 23 can be enlarged by elongating the lower inner wall surface 23L of the passage portion 23 along the thickness direction of the flange portion 24. However, the condition L≦10 mm cannot be satisfied. In order to satisfy the condition L≦10 mm, it is necessary to set the angle θ equal to or more than 60°.

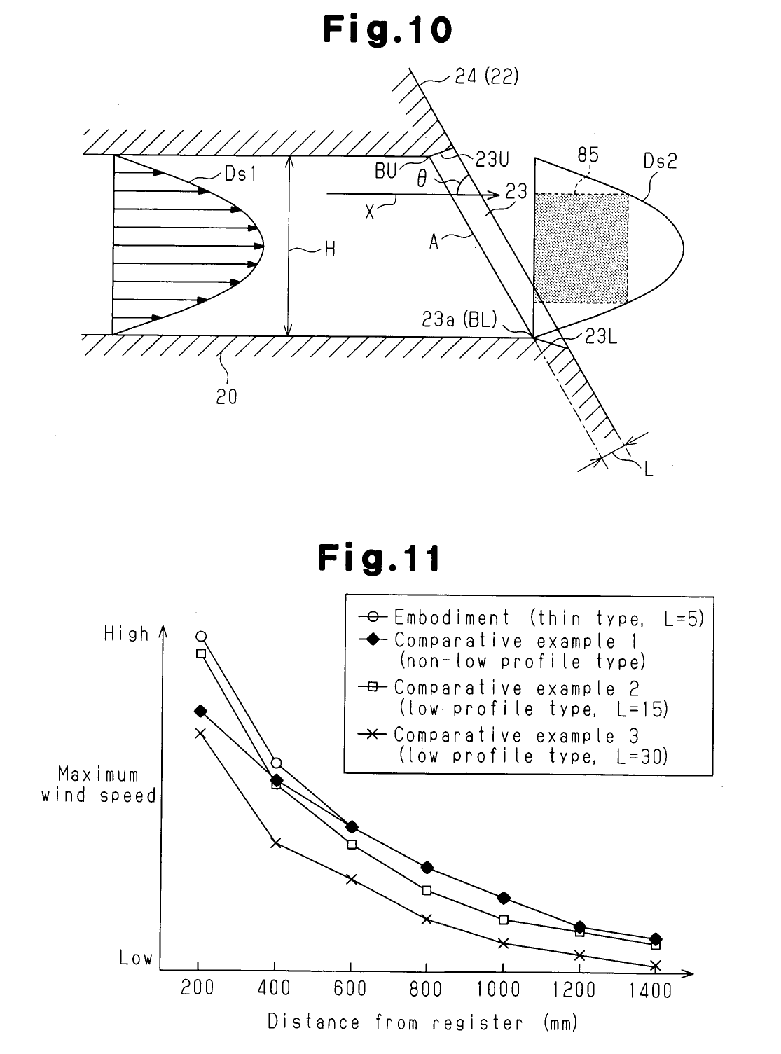

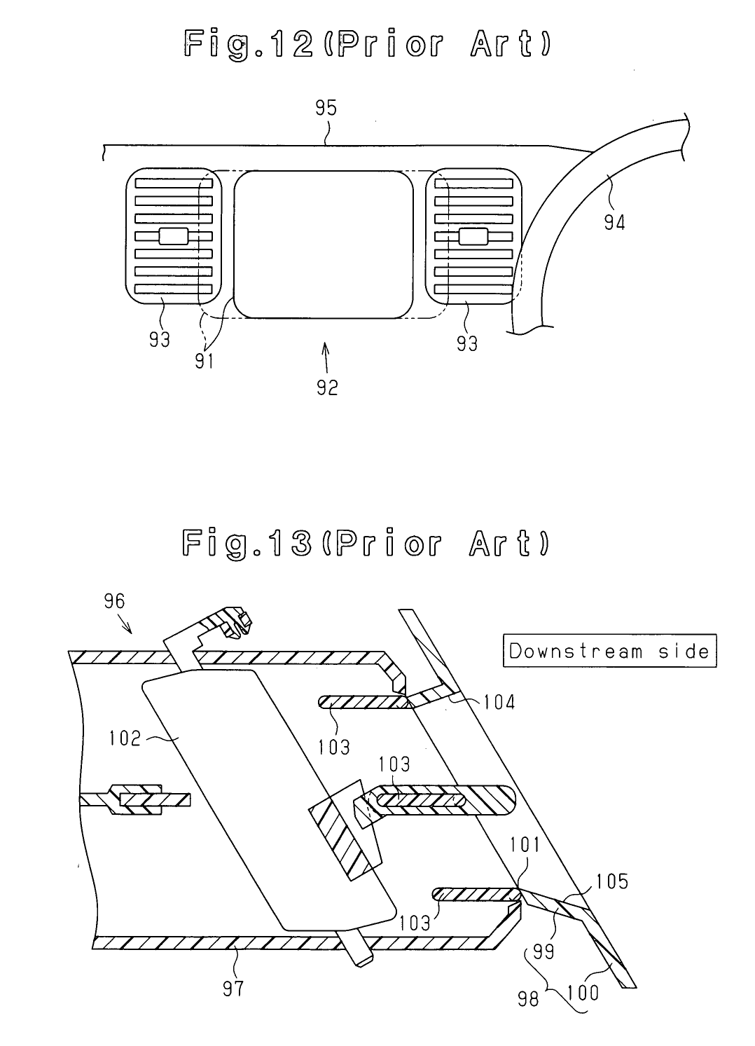

The reason why the length H is set equal to or less than 35 mm is shown below. As shown in FIG. 10, a magnitude of the main stream (the potential core layer) in the flow speed distribution Ds2 is approximately constant regardless of the magnitude of the flow rate distribution Ds2. Accordingly, if the length H becomes longer than 35 mm, the lower inner wall surface 23L of the passage portion 23 separates from the main stream 85, and influence given to the main stream 85 by the inner wall surface 23L becomes small. The Coanda flow is thus hardly generated. As a result, the intensity of the wind is not disadvantageously reduced due to the Coanda flow. Accordingly, the length H is limited to be equal to or less than 35 mm as mentioned above.

The length of the inner wall surface 23L in which the reduction of the flow rate caused by the Coanda flow is allowed is 10 mm or less. In other words, if the length L is equal to or less than 10 mm, the reduction amount of the flow rate is negligible, however, if the length L gets over 10 mm, the reduction amount of the flow rate gets over an allowable range.

As shown in FIG. 3, in the low-profile air conditioning register 15 mentioned above, the shut damper 80 is rotated around the support shaft 83 on the basis of the operation of the damper operating portion. If the shut damper 80 is rotated so as to be arranged in parallel to the ventilation direction X, the flow path within the retainer 20 is fully opened, and the distribution of the air is allowed. In contrast, if the shut damper 80 is inclined and the seal member 82 comes into contact with the upper and lower wall portions 28 and 29, the flow path within the retainer 20 is closed, and the distribution of the air is shut off.

If the operating knob 71 is operated to the right and left in the state in which the shut damper 80 is fully opened, an engaging position between the rack gear 72 and the pinion gear 73 is changed, and the specific upstream fin 61 provided with the pinion gear 73 is tilted in the same direction as the operating knob 71 around the support shafts 62 and 63. The movement of the upstream fin 61 is transmitted to all the other upstream fins 61 via the link mechanism 68. As a result, all the upstream fins 61 are synchronously tilted. Since the air flows along the tilted upstream fins 61, the direction of the air blown out of the opening 23a of the bezel 22 is changed to the right and left.

Further, in a state (a neutral state) in which the shut damper 80 is fully opened, and the intermediate fin 43 is arranged in parallel to the ventilation direction X on the basis of the operation of the operating knob 71, the end fins 41 and 42 coupled to the intermediate fin 43 by the link mechanism 50 are also arranged horizontally. Accordingly, the air flows along both end fins 41 and 42 and the intermediate fin 43 after passing through the shut damper 80 and the upstream fin group 60, thereby being blown out straightly to the rear side of the vehicle from the opening 23a of the bezel 22.

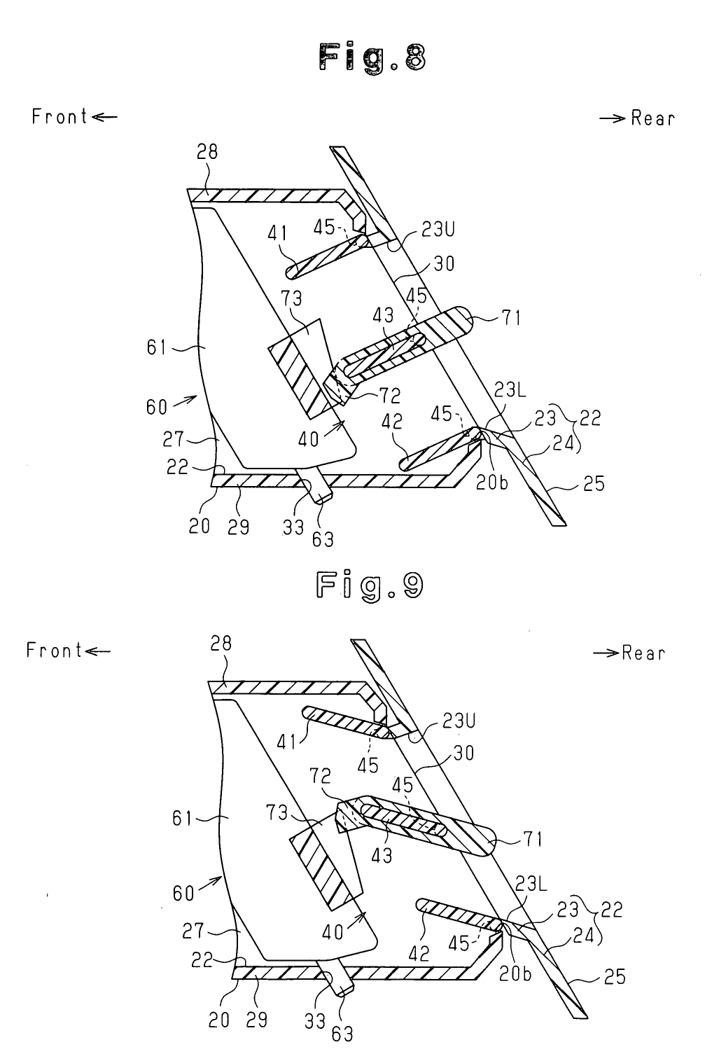

From the neutral state, if the operating knob 71 is operated upward as shown in FIG. 8, the intermediate fin 43 is rotated counterclockwise around the support shaft 45. The end fins 41 and 42 coupled to the intermediate fin 43 by the link mechanism 50 are also rotated in the same direction as the intermediate fin 43 around the support shaft 45 while keeping the parallel state with respect to the intermediate fin 43. As a result, the end fins 41 and 42 and the intermediate fin 43 are inclined so as to be higher toward the downstream side. Accordingly, the air flows along both end fins 41 and 42 and the intermediate fin 43 after passing through the shut damper 80 and the upstream fin group 60, thereby being blown out of the opening 23a of the bezel 22 diagonally upward.

On the contrary, if the operating knob 71 is operated downward as shown in FIG. 9 from the neutral state shown in FIG. 3, the intermediate fin 43 is rotated clockwise around the support shaft 45. The end fins 41 and 42 coupled to the intermediate fin 43 by the link mechanism 50 are also rotated in the same direction as the intermediate fin 43 around the support shaft 45 while keeping the parallel state to the intermediate fin 43. As a result, the end fins 41 and 42 and the intermediate fin 43 are inclined to be lower toward the downstream side. Accordingly, the air flows along the end fins 41 and 42 and the intermediate fin 43 after passing through the shut damper 80 and the upstream fin group 60, thereby being blown out of the opening 23a of the bezel 22 diagonally downward.

As mentioned above, the angle of inclination of the end fins 41 and 42 and the intermediate fin 43 is changed on the basis of the upward or downward operation of the operating knob 71, and the direction of the wind blown out of the opening 23a of the bezel 22 is changed.

In the case that the support shaft 45 is provided in a position other than the downstream ends in the intermediate fin 43 and the end fins 41 and 42, the portion downstream of the support shaft 45 is moved at a time when the intermediate fin 43 and the end fins 41 and 42 are tilted, and the outer appearance deteriorates. In this regard, in the present embodiment, since the support shaft 45 is provided in the downstream end of each of the fins 41 to 43, the portion downstream of the support shaft 45 is hardly moved at a time when the intermediate fin 43 and the end fins 41 and 42 are tilted.

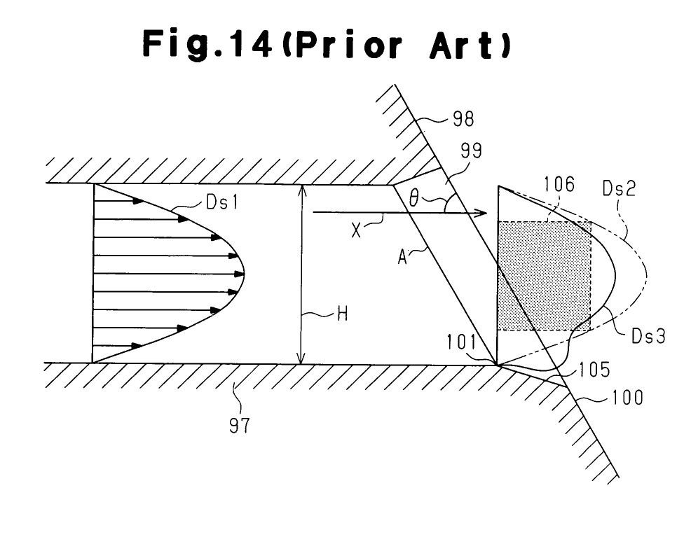

FIG. 10 is a view corresponding to FIG. 14, and shows the flow rate distribution Ds1 of air flowing within the retainer 20, and the flow rate distribution Ds2 of the air flowing through the opening 23a of the bezel 22. In order to facilitate explanation, the shut damper 80 and the upstream fin group 60 and the downstream fin group 40 within the retainer 20 are omitted. Accordingly, the influence given by each of the members within the retainer 20 is excluded from the flow rate distributions Ds1 and Ds2.

As shown in FIG. 10, the flow rate distribution Ds1 of the air becomes maximum in the center of the flow path within the retainer 20, and becomes smaller as the distance from the center portion increases. This is because the air is exposed to friction generated by the inner wall of the retainer 20. Originally, it is desirable that the flow rate distribution Ds2 of the air flowing through the opening 23a of the bezel 22 be equal to the flow rate distribution Ds1.

In the passage portion 23, the lower inner wall surface 23L is inclined with respect to the ventilation direction X in such a manner as to expand the interval between the lower inner wall surface 23L and the upper inner wall surface 23U as the distance from the downstream side decreases. In other words, the lower inner wall surface 23L is arranged so as to becomes lower toward the downstream side. Accordingly, if the inner wall surface 23L is too long along the ventilation direction X, the Coanda flow caused by the inner wall surface 23L is generated, and the main stream 85 in the flow rate distribution Ds2 is pulled toward the inner wall surface 23L.

In this regard, in the present embodiment, the length L of the lower inner wall surface 23L is set to 5 mm in such a manner as to satisfy the condition (L≦10 mm) mentioned above. Accordingly, the Coanda flow caused by the inner wall surface 23L is suppressed. Therefore, it is possible to suppress such a phenomenon that the flow rate distribution Ds2 comes to a different shape from the original flow rate distribution, whereby the flow rate of the air is largely lowered. Accordingly the flow rate distribution Ds2 of the air flowing through the opening 23a of the bezel 22 becomes equal to the flow rate distribution Ds1 within the retainer 20.

In accordance with the present embodiment in detail mentioned above, the following advantages are obtained.

(1) In the bezel 22 having the flange portion 24 which is inclined with respect to the ventilation direction X of the wind flowing within the retainer 20, the inner wall surface 23L including the lower long side BL has the length L equal to or less than 10 mm (5 mm in this case) along the thickness direction of the flange portion 24, in the opening 23a of the passage portion 23. Accordingly, it is possible to inhibit the wind speed from being lowered due to the Coanda flow. Accordingly, the flow rate distribution Ds2 of the air flowing through the opening 23a of the bezel 22 becomes equal to the flow rate distribution Ds1 within the retainer 20. Therefore, it is possible to sufficiently secure the intensity (the wind speed) of the wind applied to the passenger.

FIG. 11 shows the relationship between the distance from the air conditioning (thin type) register and the maximum wind speed. In FIG. 11, a comparative example 1 shows results of measurement in the case of using a non-low-profile air conditioning register. In the air conditioning register, the length H is set to 40 mm, and an aspect ratio (the length of the lower and upper long sides BL and BU/the length of the short sides AL, AR) is set to 2.0. The characteristic of the maximum wind speed in the comparative example 1 is set as a reference at the time of evaluating the characteristic of the maximum wind speed in an example, a comparative example 2, and a comparative example 3.

The example shows the results of measurement in the case of using the low-profile air conditioning register 15 in accordance with the embodiment mentioned above. In this low-profile air conditioning register, the length L is set to 5 mm. The comparative example 2 shows the results of measurement in the case of using the low-profile air conditioning register in which the length L is set to 15 mm, and the comparative example 3 shows the results of measurement in the case of using the low-profile air conditioning register in which the length L is set to 30 mm.

In accordance with FIG. 11, the maximum wind speed is reduced as the distance from the air conditioning (thin type) register increases, in any case of the example and the comparative examples 1 to 3. Although the common tendency mentioned above is obtained, the maximum wind speed in the example is equal to or more than the comparative example 1 regardless of the distance from the low-profile air conditioning register. In contrast, in the case of the comparative example 2, the maximum wind speed is higher than the comparative example 1 at the position which is 200 mm away from the low-profile air conditioning register, however, is lower than the comparative example 1 at the position which is 400 mm or more away therefrom. Further, in the case of the comparative example 3, the maximum wind speed is largely lower than the comparative example 1 and the comparative example 2 in spite of the distance from the low-profile air conditioning register.

(2) In the case of the thin type retainer 20, the size in the arranging direction of the downstream fins 41 to 43 is small. Accordingly, if the end fins 41 and 42 are displaced inward and separated from the upper and lower long sides BU and BL of the opening 23a, the interval between the adjacent downstream fins becomes narrow even in the case that each of the downstream fins is set in parallel to the ventilation direction X. Further, if the angle of inclination with respect to the ventilation direction of each of the downstream fins becomes larger, the interval between the adjacent downstream fins becomes narrow, and it is impossible to secure the flow path having a sufficient width between the adjacent downstream fins.

In this regard, in the present embodiment, the end fins 41 and 42 are respectively arranged near the upper and lower long sides BU and BL of the opening 23a, as shown in FIG. 3. On the basis of this arrangement, the interval between the end fin 41 and the upper long side BU, and the interval between the end fin 42 and the lower long side BL are narrowed, and the interval in the arranging direction between both end fins 41 and 42 becomes larger, accordingly. Thus, even in the thin retainer 20, the interval between the adjacent end fin 41 and the intermediate fin 43, and the interval between the end fin 42 and the intermediate fin 43 become larger, and it is possible to secure the flow path having the sufficient width between the adjacent downstream fins (refer to FIGS. 8 and 9).

(3) In connection with the item (2), in the present embodiment, the downstream fin group 40 is constituted by a pair of end fins 41 and 42, and one intermediate fin 43 arranged in the center of both end fins 41 and 42. Accordingly, the wind direction regulating function is achieved, the interval between the adjacent downstream fins becomes large, and the flow path having the sufficient width is secured.

(4) The end fins 41 and 42 and the intermediate fin 43 are supported by the support shaft 45 provided in the downstream ends thereof in such a manner as to be tiltable with respect to the left and right wall portions 26 and 27. Accordingly, since the portion near the downstream end of each of the fins 41 to 43 is hardly moved at a time when the end fins 41 and 42 and the intermediate fin 43 are tilted, the outer appearance is improved.

(5) In the retainer 20, the upper wall portion 28 is provided in a position higher than the upper long side BU of the opening 23a, and the lower wall portion 29 is provided in the lower position than the lower long side BL of the opening 23a. Further, the end fin 41 is arranged between the upper long side BU of the opening 23a and the upper wall portion 28, and the lower end fin 42 is arranged between the lower long side BL of the opening 23a and the lower wall portion 29. On the basis of these arrangements, since the fins 41 and 42 are not visible from the driver's seat and the front passenger seat side, the ornamentality is further improved.

The present invention may be modified as shown below.

The present invention may be applied to a low-profile air conditioning register having a vertically long opening 23a. In this case, in the retainer 20, a pair of laterally opposing wall portions correspond to the first and second wall portions 28 and 29. Further, in this case, the end fins 41 and 42 and the intermediate fin 43 corresponding to the downstream fin are arranged along the vehicle width direction, and a plurality of upstream fins 61 are arranged along the vertical direction.

The downstream fin group 40 may be constituted by the end fins 41 and 42, the intermediate fin 43 and the other downstream fins.

In the passage portion 23, it is necessary that the lower inner wall surface 23L be inclined with respect to the ventilation direction X. However, the upper inner wall surface 23U does not necessarily be inclined with respect to the ventilation direction X. It is preferable that the inner wall surface 23L be inclined with respect to the ventilation direction X in such a manner that the interval between the inner wall surface 23L and the inner wall surface 23U becomes larger toward the downstream side.

The present invention may be applied to a low-profile air conditioning register in which the flange portion 24 of the bezel 22 is inclined in an inverse direction to the above illustrated embodiment. In this case, the upper long side BU in the opening 23a is arranged downstream of the lower long side BL. In other words, the flange portion 24 is arranged so as to be inclined in such a manner as to recede from the driver's seat and the front passenger seat toward the lower side.

The present invention may be applied to a low-profile air conditioning register in which the retainer 20 is arranged in a state in which the ventilation direction X is inclined with respect to the horizontal plane.

The present invention may be widely applied to a low-profile air conditioning register in which the angle θ is equal to or more than 60°, and the height H is equal to or less than 35 mm.

The length L of the inner wall surface 23L may be changed to any dimension as long as the length is equal to or less than 10 mm.

It is possible to omit the members and parts which are not directly related to the features of the present invention. Alternatively, the shapes and numbers of such members and parts may be changed. For example, the upstream fin 61 and the shut damper 80 may be omitted, or the shapes and numbers of the fin 61 and the shut damper 80 may be changed.

1. An air conditioning register for regulating a direction of air blown out of an air conditioner into a passenger compartment, the register comprising:
a tubular retainer;
a bezel provided in a downstream end of the retainer;
the bezel having a passage portion distributing the air from the interior of the retainer, and a flange portion provided in the periphery of a downstream end of the passage portion;
an opening positioned in an upstream end of the passage portion, the opening being formed in a rectangular shape and having first and second long sides and first and second short sides;
a plurality of fins arranged along the first short side of the opening and in a state of being spaced from each other;
each of the fins being arranged so as to be adjustable in angle within the retainer;
the flange portion and a ventilation direction within the retainer intersecting at an angle equal to or more than 60° in such a manner that the first long side in the opening is positioned downstream of the second long side;
the length of a side corresponding line to the first short side of the opening being equal to or less than 35 mm in a plane which is orthogonal to the ventilation direction;
an inner wall surface including the first long side in the passage portion being inclined with respect to the ventilation direction in such a manner as to enlarge the interval between the inner wall surface and an inner wall surface including the second long side as the distance from a downward side decreases; and
an inner wall surface including the first long side having a length equal to or less than 10 mm along a thickness direction of the flange portion.

2. The low-profile air conditioning register according to claim 1, wherein a specific one of the fins is arranged near the first long side or the second long side of the opening.

3. The low-profile air conditioning register according to claim 1, wherein the fins include a pair of end fins arranged close to the first and second long sides of the opening, and one intermediate fin arranged in the center between the end fins.

4. The low-profile air conditioning register according to claim 2, wherein the retainer has a pair of wall portions corresponding to the first and second long sides of the opening, wherein a first wall portion is provided in a position further outside than the first long side of the opening, and a second wall portion is provided in a position further outside than the second long side of the opening, and wherein a fin located close to the first long side is located between the first long side of the opening and the first wall portion, and a fin located close to the second long side is located between the second long side of the opening and the second wall portion.

5. The low-profile air conditioning register according to claim 1, wherein the fins are supported to the wall portion of the retainer by a support shaft provided in a downstream end of the fins.
